(19) United States
(12) Patent Application Publication
(10) Pub. No.: US 2007/0063658 A1
(43) Pub. Date: Mar. 22, 2007

(54) Ballast

(75) Inventor: Renatus Willem Clemens Van Der Veeken, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/576,160

(22) PCT Filed: Oct. 19, 2004
(86) PCT No.: PCT/IB04/52137

§ 371 Date: Apr. 19, 2006

(30) Foreign Application Priority Data
Oct. 24, 2003 (EP) 03103957.1

(51) Int. Cl. H05B 39/04

(52) U.S. Cl. 315/209 R

(57) ABSTRACT

Ballast for operating a low-pressure mercury vapor discharge lamp having two luminescent portions each radiating in a different color, said ballast comprising AC supply means for supplying an AC current to the lamp, wherein the ballast further comprises DC supply means for simultaneously supplying a DC current to the lamp, said DC supply means having means for changing the intensity and/or direction of said DC current.

The invention relates to a ballast for operating a low-pressure mercury vapor discharge lamp, said ballast comprising AC supply means for supplying an AC current to the lamp.

In mercury vapor discharge lamps, mercury constitutes the primary component for the (efficient) generation of ultraviolet (UV) light. A luminescent layer comprising a luminescent material (for example, a fluorescent powder) may be present on an inner wall of (a portion of) the discharge vessel to convert UV to other wavelengths, for example, to UV-B and UV-A for tanning purposes (sun panel lamps) or to visible radiation for general illumination purposes. Such discharge lamps are therefore also referred to as fluorescent lamps. The discharge vessel of low-pressure mercury vapor discharge lamps is usually circular and comprises both elongate and compact embodiments. Generally, the tubular discharge vessel of compact fluorescence lamps comprises a collection of relatively short straight parts having a relatively small diameter, which straight parts are connected together by means of bridge parts or via bent parts. Compact fluorescent lamps are usually provided with an (integrated) lamp cap.

The goal of the invention is to provide a cost effective low-pressure mercury vapor discharge lamp system wherein the color temperature of the lamp can be easily adjusted.

A discharge vessel of a low-pressure mercury vapor discharge lamp having two luminescent portions each radiating in a different color, with two electrodes and operating under DC conditions, has a gradient in mercury density over the length of the discharge space. Due to this gradient in mercury density, e.g. the first portion of the discharge vessel contains more mercury (ions) than the second portion. The light output of the first portion of the discharge vessel is enhanced and the light output of the second portion is relatively low. In this situation, the light emitted by the low-pressure mercury vapor discharge lamp according to the invention largely corresponds to the electromagnetic spectrum emitted by the first portion. If the polarity of the DC current is reversed, the other electrode becomes the cathode and the gradient in mercury density (gradually) reverses, thereby enhancing the light output of the second portion of the discharge vessel at the cost of the light output of the first portion which is lowered. In this situation, the light emitted by the low-pressure mercury vapor discharge lamp according to the invention largely corresponds to the electromagnetic spectrum emitted by the second portion. By regulating the level of the DC current in the discharge vessel, the light emitted by the low-pressure mercury vapor discharge lamp according to the invention can be a mix between the electromagnetic spectrum emitted by the first portion and the second portion of the discharge vessel. In this manner, a low-pressure mercury vapor discharge lamp with an adjustable light emission spectrum is realized comprising only two electrodes.

According to the invention the ballast further comprises DC supply means for simultaneously supplying a DC current to the lamp, said DC supply means having means for changing the intensity and/or direction of said DC current. The invention thereby provides a way to change the color temperature of a discharge lamp having two luminescent portions each radiating in a different color, by variation of the DC current component of the electric current through the lamp. Typically the means for supplying the AC current comprise a half-bridge converter.

Preferably the DC supply means comprise a switch connected in parallel with one of the capacitors of the half-bridge converter, such that when the switch is closed the capacitor is shunted. Thereby a DC current through the lamp is obtained, thereby invoking a change in color temperature of the lamp.

Said parallel connection is preferably provided with an impedance, preferably a variable impedance, such that the amount of DC current through can be controlled, and thereby the amount of change in color temperature of the lamp.

In a first preferred embodiment the switch is a bi-polar switch, and the switch is connected in parallel with the second capacitor of the half-bridge over the second pole, such that when the switch is closed onto the second pole the second capacitor is shunted. Preferably the switch has a third neutral position, wherein the capacitors are not shunted, such that normal AC operation of the ballast is obtained. In this way a cost effective three-color lamp ballast is obtained.

This embodiment can be further enhanced by using a multi-position switch and using different series of impedances for intermediate DC electric currents.

In a second preferred embodiment the DC supply means comprise a second switch connected in parallel with the second capacitor of the half-bridge converter, such that when the second switch is closed the second capacitor is shunted. Preferably the two switches are electronically controlled switches, being capable of operating independently of the electronically controlled switches of the half-bridge converter. The on-off time (duty cycle) of the switches determines the actual DC component in the electric current through the lamp. In this way the adjustment of the DC current component can be done continuously from −100% to +100% and a continuous color control is achieved.

These and other aspects of the invention are apparent from and will be elucidated with reference to the embodiments described hereinafter.

In the drawings:

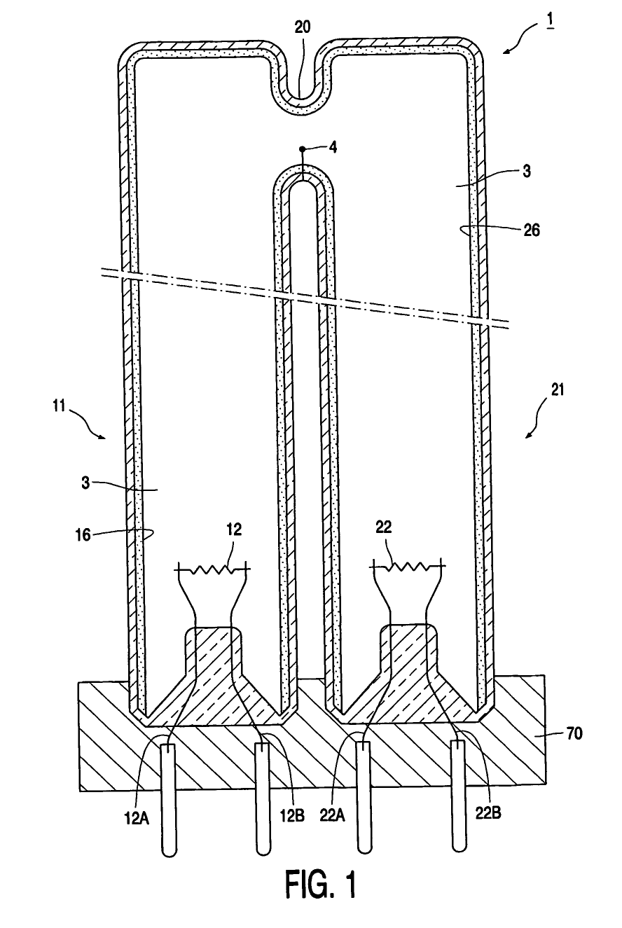

FIG. 1 is a cross-sectional view of an embodiment of a compact fluorescent lamp comprising a low-pressure mercury-vapor discharge lamp;

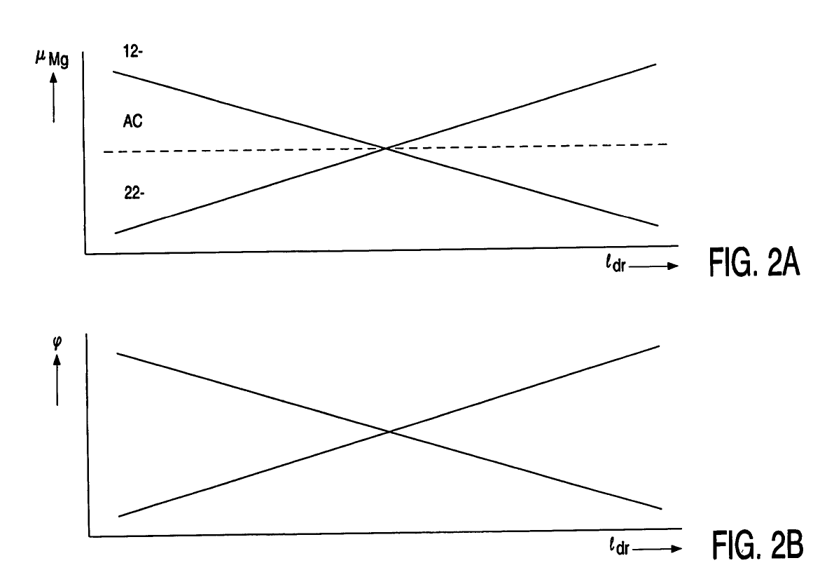

FIG. 2A is a graph of the mercury density against the position in the discharge vessel of the lamp;

FIG. 2B is a graph of the light output against the position in the discharge vessel of the lamp;

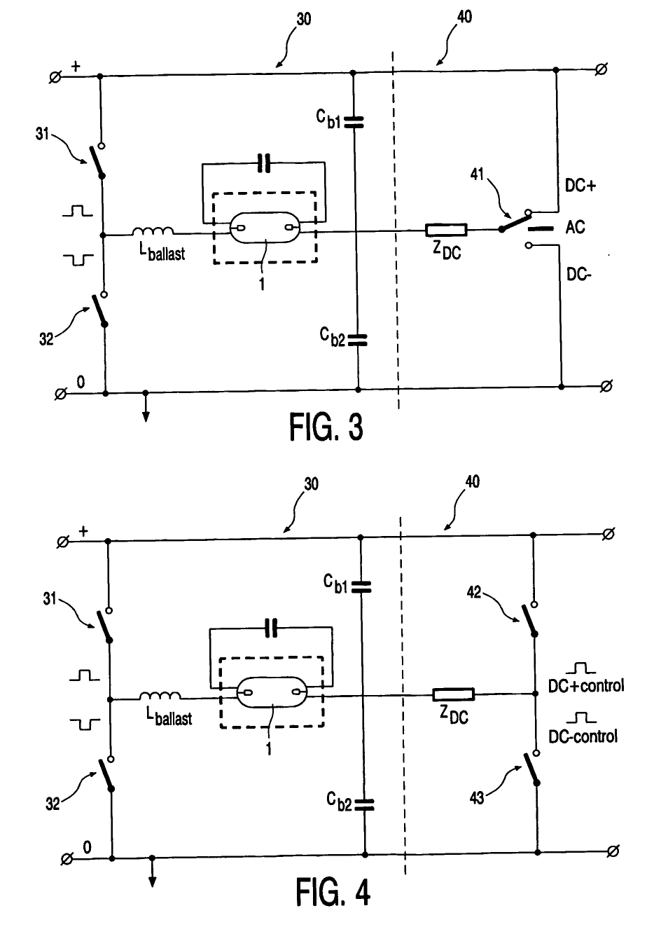

FIG. 3 is a schematic view of a first embodiment of the circuit of a ballast in accordance with the invention; and

FIG. 4 is a schematic view of a second embodiment of the circuit of a ballast in accordance with the invention.

The Figures are purely diagrammatic and not drawn to scale. Particularly for clarity, some dimensions are exaggerated strongly. Similar components in the Figures are denoted as much as possible by the same reference numerals.

FIG. 1 shows a compact fluorescent lamp comprising a low-pressure mercury-vapor discharge lamp. Said low-pressure mercury-vapor discharge lamp is provided with a radiation-transmitting discharge vessel 1 which encloses a discharge space 3 having a volume of approximately 10 cm³ to 100 cm³ in a gastight manner. The discharge vessel 1 is a glass tube which is at least substantially circular in cross-section and which has an (effective) inner diameter of approximately 10 mm to 25 mm. The discharge vessel 1 comprises a first portion 11 and a second portion 21. In the example of FIG. 1 the first and the second portion 11, 21 are interconnected via a channel or bridge 20. In an alternative embodiment, the discharge vessel is folded and e.g. comprises bent parts. A first portion 11 of the discharge vessel 1 is provided with a first electrode 12 arranged in the discharge space 3. At an inner wall of the first portion 11 of the discharge vessel 1 a luminescent layer 16 is provided. In operation, the first portion 11 radiates light in a first range of the electromagnetic spectrum from 100 to 1000 nm. By way of example the first range may correspond to a first color temperature, the first color temperature being e.g. 2700 K. A second portion 21 of the discharge vessel 1 is provided with a second electrode 22 arranged in the discharge space 3. In the example of FIG. 1, a further luminescent layer 26 is provided at an inner wall of the second portion 21 of the discharge vessel 1. In operation, the second portion 21 radiates light in a second range of the electromagnetic spectrum from 100 to 1000 nm. By way of example the second range may correspond to a second color temperature, the second color temperature being e.g. 6500 K. In an alternative embodiment, the further luminescent layer is omitted. In that case, the wall of the second portion of the discharge vessel, preferably, is made from a glass which is transmissible to UV, said second portion emitting e.g. UV-C. In a further alternative embodiment one of the first portion emits UV-A and the second portion emits UV-B. The skilled person easily conceives additional variations of emission spectra emitted by the first and second portion of the discharge vessel of the low-pressure mercury vapor discharge lamp within the scope of the invention.

The electrode pair 12; 22 generally is a winding of tungsten covered with an electron-emitting substance, in this case a mixture of barium oxide, calcium oxide and strontium oxide. Each of the electrodes 12; 22 is supported by a (narrowed) end portion of the discharge vessel 1. Current supply conductors 12A, 12B; 22A, 22B extend from the electrode pair 12; 22 through the end portions of the discharge vessel 1 where they issue to the exterior. The current supply conductors 12A, 12B; 22A, 22B are connected to an (electronic) power supply. For the application of DC currents to the electrodes, in principle, it is sufficient if either the current supply conductors 12A and 22A or the current supply conductors 12B and 22B. If the low-pressure mercury vapor discharge lamp operates under DC operation only, half of the number of current supply conductors can be omitted.

The discharge vessel 10 of the low-pressure mercury-vapor discharge lamp can be surrounded by a light-transmitting envelope (not shown in FIG. 1), which is secured to the lamp housing 70. The light-transmitting envelope generally has a matt appearance.

In the example of FIG. 1, mercury is not only present in the discharge space 3 but also in an amalgam 4 provided in the region between the first and the second portion 11, 21 of the discharge vessel 1. In an alternative embodiment, the amalgam is provided in the region of the electrode of the portion of the discharge vessel with the lowest color temperature.

In a further alternative embodiment, the amalgam is provided in the region of the first electrode and a further amalgam is provided in the region of the second electrode. In operation, the amalgam 4 is in communication with the discharge space 3. In an alternative embodiment, the discharge vessel is further provided with a so-called auxiliary amalgam (not shown in FIG. 1).

FIG. 2A shows schematically, the mercury density mHg as a function of the position I_{dv} in the discharge vessel 1. FIG. 2B shows schematically the corresponding light output j of the discharge vessel 1 as a function of the position I_{dv} in the discharge vessel. When the discharge lamp is operated on a DC current (with an electronic circuit), the mercury ions will drift towards the cathode side of the lamp. This leads to a gradient in the mercury distribution and accordingly to a gradient in the light output as can be seen in FIGS. 2A and 2B. When electrode 12 is the cathode (indicated by “12-” in FIG. 2A), the light output will have the emission spectrum, e.g. a first color temperature, corresponding to the first portion 12 of the discharge vessel 1. When the second electrode 22 is made cathode (indicated by “22-” in FIG. 2A), the light will have the emission spectrum, e.g. a second color temperature, according to the second portion 22 of the discharge vessel 1. By regulating the DC level of the current, the emission spectrum, e.g. the color temperature, of the discharge lamp is made adjustable. Since the amalgam 4 is positioned in the middle of the discharge vessel, the mercury pressure above the amalgam is constant and independent of the DC polarity. This ensures a minimal time between the change of color.

By decreasing the level of the DC current, the power in the discharge vessel 1 decreases and therefore the temperature of the amalgam 4 lowers and the total mercury density lowers. This implied that the light output of both the first and the second portion 11; 21 shifts to the left over the light output versus mercury density curve. This results in a lower light output for the portion with the higher color temperature and an increased light output for the portion with the lower color temperature. By dimming, the color temperature shifts to lower temperatures, as is the case in normal incandescent lamps. In an alternative embodiment a so-called cold spot instead of an amalgam is used.

FIG. 2A also shows the situation in which the low-pressure mercury vapor discharge lamp operates under AC current conditions. In this situation, the light from both portions mix to a color temperature which lies approximately in between the first and the second color temperature.

FIG. 3 schematically shows in part a first embodiment of a ballast circuit to which the lamp 1 can be connected. The ballast comprises means 30 for providing an AC current to the lamp 1, the AC supply means is a half-bridge converter well known in the art, comprising a LC-resonance circuit with a coil Lballast, two capacitors C_{b1}, C_{b2} and electronically operated switches 31, 32, which alternately are switched on and off at a high frequency, thereby converting the DC current provided by the DC current supply (not shown) in a high frequency AC current to the lamp 1.

According to the invention means 40 are provided for simultaneously providing a DC current component to the lamp 1. These means comprise a bi-polar switch 41 which is connected at one end through an impedance Z_{DC} with one of the electrodes of the lamp, to which also the capacitors C_{b1}), C_{b2} are connected. The two poles of the switch 41 are connected to the respective poles of the DC current supply. There is also a third neutral position in which the switch 41 can be positioned. In the position as shown in FIG. 3 the capacitor Cb1 is shunted, and a direct current component can run through the lamp 1. If the switch 41 is switched to the other pole, the capacitor C_{b2} is shunted, and a direct current component runs through the lamp into the other direction. In the neutral position the ballast operates in normal AC mode. The amount of the DC current component can be controlled by choosing an appropriate value for Z_{DC}, which is preferably variable such that it can be set by the user.

According to FIG. 4 the DC current supply means 40 comprise two electronically controlled switches 42, 43. These switches 42, 43 are not operated alternately like the half-bridge switches 31, 32, but are operated independently thereof and of each other.

They can be both open, or one of them can be shut permanently or switched on and off at a switching frequency. This frequency does not need to be very high, as the purpose hereof is to achieve a desired duty cycle, determined by the on-off time of the switches 42, 43. In this way the amount and direction of the DC current component through the lamp 1, and thereby the color temperature, can be set in a precise manner.

It will be evident that many variations within the scope of the invention can be conceived by those skilled in the art.

The scope of the invention is not limited to the embodiments. The invention resides in each new characteristic feature and each combination of novel characteristic features. Any reference signs do not limit the scope of the claims. The word “comprising ” does not exclude the presence of other elements or steps than those listed in a claim. Use of the word “a” or “an” preceding an element does not exclude the presence of a plurality of such elements.

1. Ballast for operating a low-pressure mercury vapor discharge lamp (1) having two luminescent portions (11, 21) each radiating in a different color, said ballast comprising AC supply means (30) for supplying an AC current to the lamp (1), characterized in that the ballast further comprises DC supply means (40) for simultaneously supplying a DC current to the lamp (1), said DC supply means (40) having means (Z_{DC}, 41, 42, 43) for changing the intensity and/or direction of said DC current.

2. Ballast according to claim 1, wherein the means (30) for supplying the AC current comprise a half-bridge converter.

3. Ballast according to claim 2, wherein the DC supply means (40) comprise a switch (41, 42) connected in parallel with one of the capacitors (Cb1) of the half-bridge converter, such that when the switch (41, 42) is closed the capacitor (Cb1) is shunted.

4. Ballast according to claim 3, wherein said parallel connection is provided with an impedance (Z_{DC}).

5. Ballast according to claim 4, wherein said impedance (Z_{DC}) is a variable impedance.

6. Ballast according to claim 3, wherein the switch is a bi-polar switch (41), and the switch is connected in parallel with the second capacitor (Cb2) of the half-bridge over the second pole, such that when the switch (41) is closed onto the second pole the second capacitor (Cb2) is shunted.

7. Ballast according to claim 6, wherein the switch (41) has a third neutral position, wherein the capacitors (Cb1, Cb2) are not shunted.

8. Ballast according to claim 3, wherein the DC supply means (40) comprise a second switch (43) connected in parallel with the second capacitor (Cb2) of the half-bridge converter, such that when the second switch (43) is closed the second capacitor (Cb2) is shunted.

9. Ballast according to claim 8, wherein the two switches (42, 43) are electronically controlled switches, being capable of operating independently of the electronically controlled switches (31, 32) of the half-bridge converter.
